(19) United States
(12) Patent Application Publication
(10) Pub. No.: US 2005/0097489 A1
(43) Pub. Date: May 5, 2005

(54) Method and system for producing a reduced bounding box

(76) Inventor: Robert Young Seward, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/699,910

(22) Filed: Nov. 3, 2003

(51) Int. Cl. G06F 9/45

(52) U.S. Cl. 716/9

(57) ABSTRACT

Systems, methodologies, media, and other embodiments associated with reducing a bounding box for a net in a VLSI design of cells, where a cell may have two or more pins by which it can be connected to one or more other cells in the design, is described. One exemplary method may include receiving the design, producing an initial bounding box for a net in the design, and reducing the initial bounding box to a reduced bounding box.

### BACKGROUND

One action performed by very large scale integration (VLSI) computer aided design (CAD) systems may be determining where to place the cells of a design that connects a net. The VLSI CAD system may attempt to reduce and/or minimize a set of design attributes like total wire length, routing congestion, timing delays, and so on, by strategically placing cells. The placement of the cells can be referred to as a VLSI design of cells or a design. Identifying when the design attributes have been minimized and/or sufficiently reduced may involve determining the route(s) that wires will take to connect the cells as placed. However, determining these routes can be computationally costly. Furthermore, the precise routes that are computed by a later design component (e.g., wire routing process) may not match the routes considered by the placing system.

Thus, VLSI CAD cell placing systems and/or processes may employ route estimates to facilitate determining the effect of various placements on the attributes to be minimized. Determining route estimates for a VLSI design of cells may involve determining bounding boxes with a minimum and/or reduced perimeter for the terminals (e.g., cell ports, cell connections) for the nets in a VLSI design of cells. The dimensions of the bounding box can be employed to compute route estimates and thus to compute other estimates for the attributes to be minimized.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example design.

FIG. 2 illustrates another example design.

FIG. 3 illustrates an example bounding box.

FIG. 4 illustrates another example bounding box.

FIG. 5 illustrates an example design that includes cells with multiple possible connecting points.

FIG. 6 illustrates two example bounding boxes that cover the cells in an example design that includes cells with multiple possible connecting points.

FIG. 7 illustrates an example design of four cells, three of which have multiple pins.

FIG. 8 illustrates an example initial bounding box that covers four cells.

FIG. 9 illustrates an example intermediate bounding box that covers the four cells of FIG. 8.

FIG. 10 illustrates an example reduced bounding box that covers the four cells of FIG. 8.

FIG. 11 illustrates an example design of two cells, each of which has multiple pins.

FIG. 12 illustrates an example initial bounding box that covers the two cells of FIG. 11.

FIG. 13 illustrates an example reduced bounding box that covers the two cells of FIG. 11.

FIG. 14 illustrates an example method for reducing a bounding box.

FIG. 15 illustrates another example method for reducing a bounding box.

FIG. 16 illustrates an example computing environment in which example systems and methods illustrated herein can operate.

FIG. 17 illustrates an example system for computing a reduced and/or minimal bounding box for a design.

FIG. 18 illustrates an example method for computing a reduced bounding box for a net in a VLSI design of cells.

### DETAILED DESCRIPTION

Example systems, methods, computer-readable mediums and so on described herein concern computing reduced, near minimal, and/or minimal bounding boxes for spanning trees in which there are cells that have terminals (e.g., pins) that may connect to more than one location. The computing complexity involved in determining bounding boxes to facilitate estimating routes and/or their effect on design attributes can be effected by a design having cells that include two or more pins by which the cell(s) can be connected to another cell(s). Thus, the example systems and methods described herein facilitate determining reduced, near minimal, and/or minimal bounding boxes for a VLSI design that may have one or more nets, where a cell in a net may have more than one pin by which it can be connected to another cell(s).

In one example, a logic is configured to perform a method that starts with an initial bounding box that covers all and/or substantially all the pins for a set of cells connected by a net in a design. During subsequent operations, an intermediate bounding box is produced when pins that can be discarded and/or ignored on an edge (side) of the bounding box are located and logically removed from the bounding box, which facilitates reducing the size of the bounding box. The method may continue reducing the size of the bounding box until the edges have pins that can not be eliminated or logically removed and/or until the bounding box has reached a size that meets a pre-determined, configurable threshold. An example threshold may concern, for example, the ratio of the area of an intermediate bounding box to the area of the initial bounding box. A logic configured to produce a reduced, near minimal and/or minimal bounding box may be able to produce a bounding box that indicates that the net could be fit into an area 85 percent the size of the initial (maximum) bounding box if a first amount of processing time were expended. However, if a reduced bounding box can be produced that indicates that the net could be fit into the available real estate using a second, lesser amount of processing time, then the logic may generate a signal that it is possible to meet the pre-determined, configurable size threshold and the logic may then be signaled to terminate its processing. In this way, during various phases of design, the wishes of a designer may be met without running an algorithm to exhaustion, which may save processing cycles. While the examples may be described with respect to computing a single bounding box for a design that includes a single net, it is to be appreciated that a design may have multiple nets and thus multiple bounding boxes may be computed using the example systems and methods described herein.

The size of the initial bounding box can be efficiently reduced in a subsequent intermediate bounding box by moving two edges at a time when possible, by removing sets of pins collectively when possible, and by selecting pins to remove or retain that have the greatest effect on the reducing the size of the intermediate bounding box. In one example, pin retention and/or removal depends on the Manhattan distance of the pin from the corner formed by the two edges that are to be moved simultaneously.

One example logic can be configured to perform a method that includes producing a reduced, near minimal and/or minimal bounding box for a net in a VLSI design of cells, where at least one cell in the VLSI design of cells includes two or more pins by which the cell can be connected to at least one other cell. The method may include producing an initial bounding box. The method may include creating electronic records that can store information about pins and ports of cells in a design connected to a net for which a bounding box is to be reduced. The method may also include storing pin data in data structures configured to store pin data. The pin data may facilitate relating a pin to an electronic record, selectively arranging the electronic records in a pre-determined order, and analyzing the selectively arranged electronic records to identify a corner case of pins. If a corner case of pins exists, the method may selectively remove pins in the corner case to produce an intermediate bounding box. After removing pins in the corner cases of pins, which can include moving two edges at the same time and collectively removing sets of pins, the method may include reducing the size of the bounding box by repetitively selectively logically removing pins from inclusion in the intermediate bounding box and repetitively selectively moving an edge of an intermediate bounding box to produce a reduced bounding box. It is to be appreciated that the logic can be configured to produce multiple bounding boxes for designs that include multiple nets.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Bounding box”, as used herein, refers to a rectangle that covers a set of pins by which a net can be connected, where the net has been laid out into a VLSI design of cells.

“Net”, as used herein, refers to the theoretical description of a circuit that describes relationships between cells, where cells include pins that are interconnected to pins on other cells in the net. A net specifies which cells are to be connected to other cells but does not specify wiring topography.

“Port”, as used herein, when referring to a portion of a cell, refers to a logical connection of a cell to other cells via a net. “Pin” is the mapping of a port into physical locations to which a net can connect. For example, a two-input “and” gate may have three logical ports: in1, in2, and out. “in1” may have two different locations (pins) that are available for connecting to a net. Similarly, “in2” may have only a single location (pin) for connecting to a net while “out” may have three different pins that can be employed to connect to a net.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an application specific integrated circuit (ASIC), a programmed logic device, a memory device containing instructions, or the like. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections.

“Signal”, as used herein, includes but is not limited to one or more electrical or optical signals, analog or digital, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, the desires of a designer/programmer, and the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, C#, C++, assembly, firmware, microcode, and/or other languages and tools. Software, whether an entire system or a component of a system, may be embodied as an article of manufacture and maintained as part of a computer-readable medium as defined previously. Another form of software may include signals that transmit program code of the software to a recipient over a network or other communication medium.

Some portions of the detailed description that follows are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is to be appreciated that throughout the description, terms like establishing, processing, computing, calculating, determining, displaying, or the like, refer to actions and processes of a computer system, logic, processor, or similar electronic device that manipulates and transforms data represented as physical (electronic) quantities.

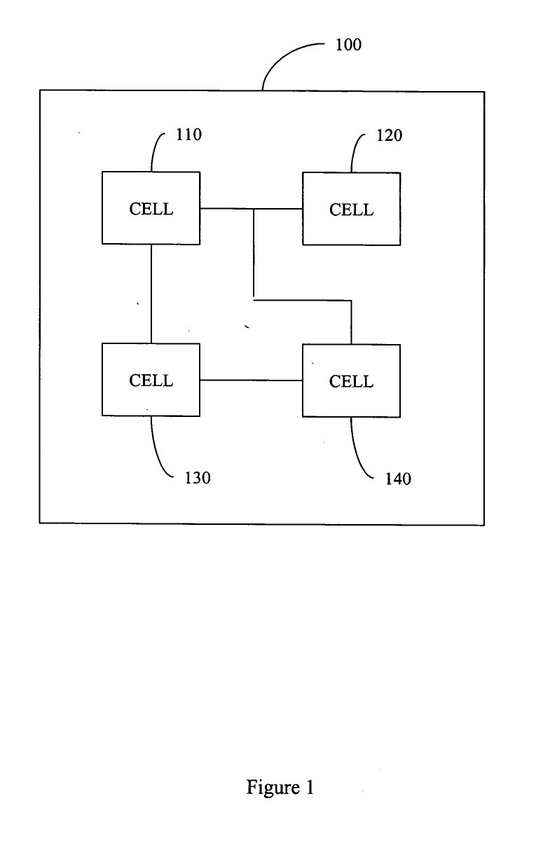

FIG. 1 illustrates an example VLSI cell design 100 that includes wire routings between cells in the design 100. The example design 100 includes a cell 110 connected to three other cells, cell 120, cell 130, and cell 140. VLSI CAD tools may attempt to place blocks (e.g., cells) in locations that facilitate minimizing a measure like wire length. Rather than measure the wire run lengths, the VLSI CAD tools may compute a bounding box from which total wire run lengths and/or other measurements can be estimated. The cells in the design 100 may represent, for example, “and” gates, “nand” gates, “or” gates, “xor” gates, multiplexers (mux), invertors, small combinations thereof, and the like. While a wire routing is illustrated in design 100, the example systems and methods described herein may be applied to designs before wire routings are established.

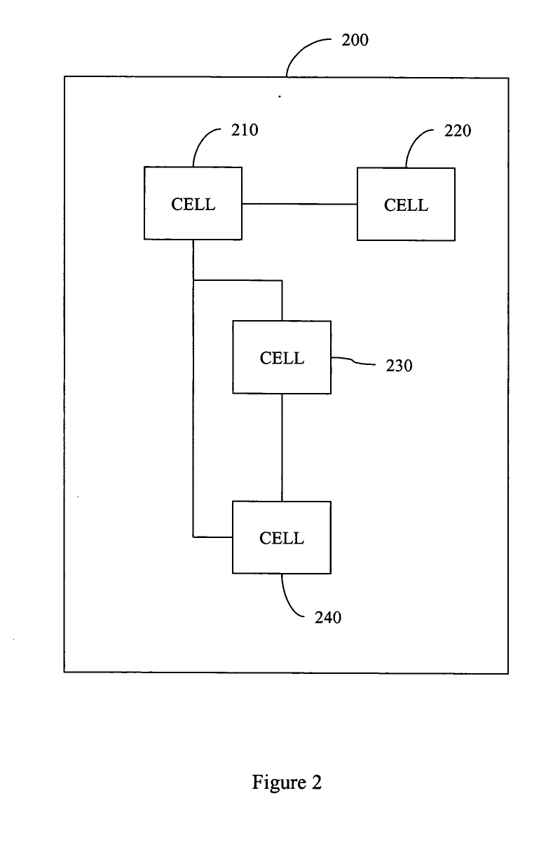

In FIG. 2, another example VLSI cell design 200 and wire routing is illustrated. The design 200 includes a cell 210 connected to three other cells, cell 220, cell 230, and cell 240 which correspond respectively to cells 110, 120, 130, and 140 in FIG. 1. The systems, methods, and so on described herein facilitate determining whether the design 200 in FIG. 2 is superior to the design 100 in FIG. 1. Comparison may be made with respect to estimable criteria like wire length estimates, delay estimates, congestion estimates, and so on by computing reduced and/or minimal bounding boxes whose areas can be compared. Once again, while a wire routing is illustrated in FIG. 2, it is to be appreciated that the example bounding box reducing systems and methods described herein may be applied before wire routings are determined, to facilitate determining which designs, if any, are likely to be routed with wire run lengths, congestion, delays, and so on that meet design thresholds.

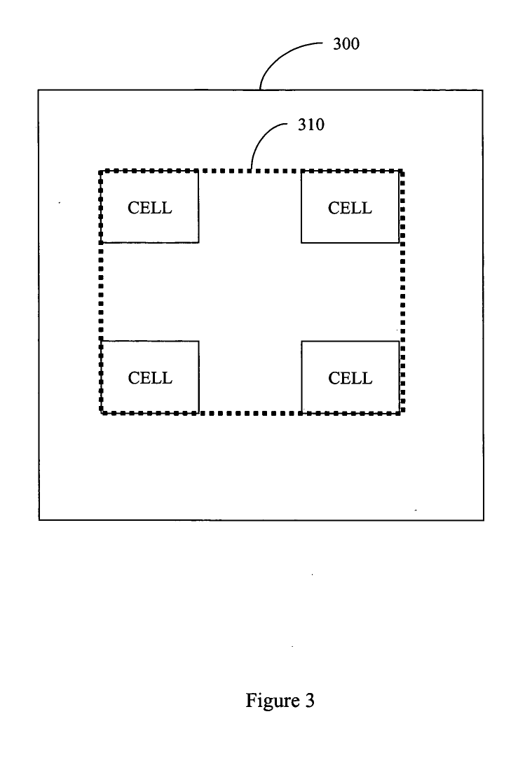

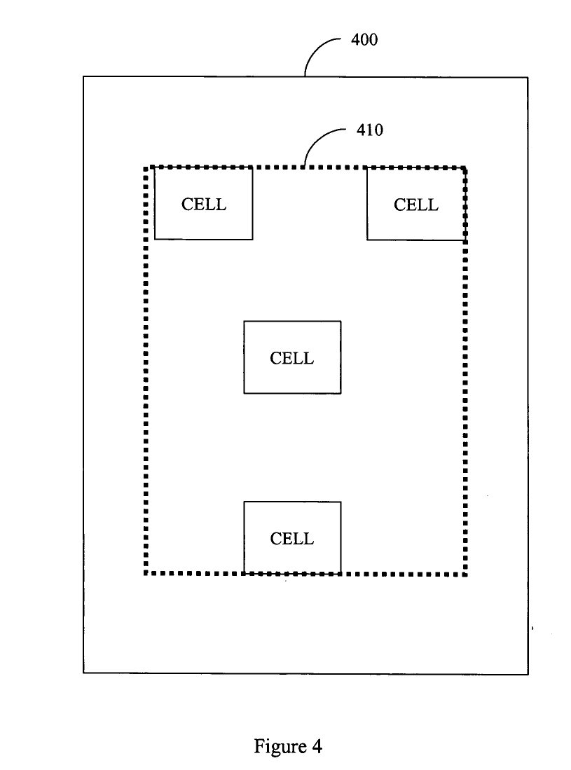

For example, FIG. 3 illustrates a design 300 that does not yet have wire routings established for which an example bounding box 310 has been computed. Similarly, FIG. 4 illustrates a design 400 that does not yet have wire routings established for which an example bounding box 410 has been computed. The bounding boxes 310 and 410 could be examined to facilitate determining whether design 300 or design 400 are acceptable designs (e.g., design criteria meet pre-determined, configurable thresholds). Furthermore, bounding boxes 310 and 410, and/or data related to them (e.g., wire estimates), can be compared to facilitate selecting between competing designs. Producing the bounding boxes 310 and 410 can be made more complex if the cells that are covered by the bounding boxes include more than one pin by which the cell can be connected to another cell(s) in the VLSI design of cells. While FIGS. 3 and 4 illustrate designs with a single net, it is to be appreciated that a design may have multiple nets for which multiple bounding boxes may be computed.

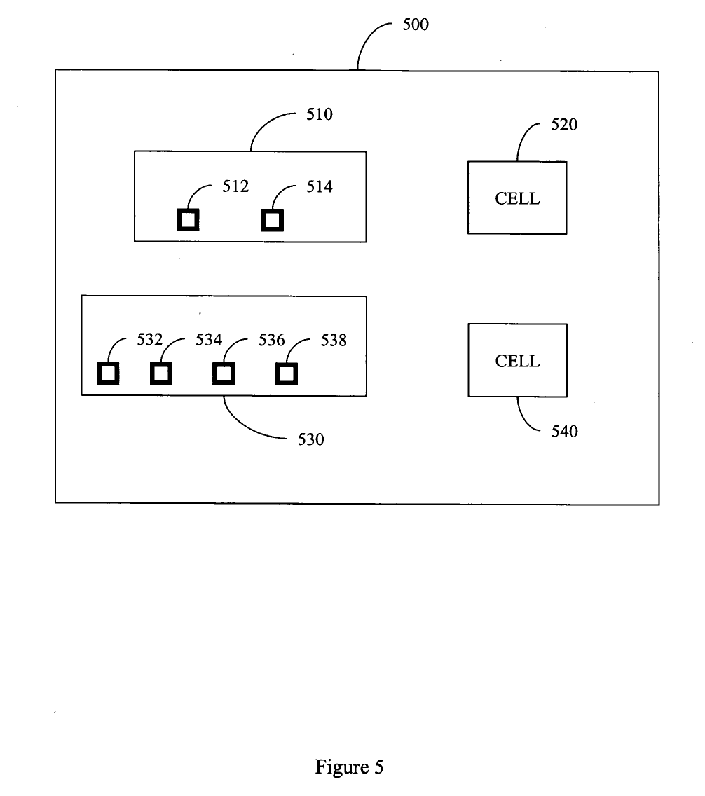

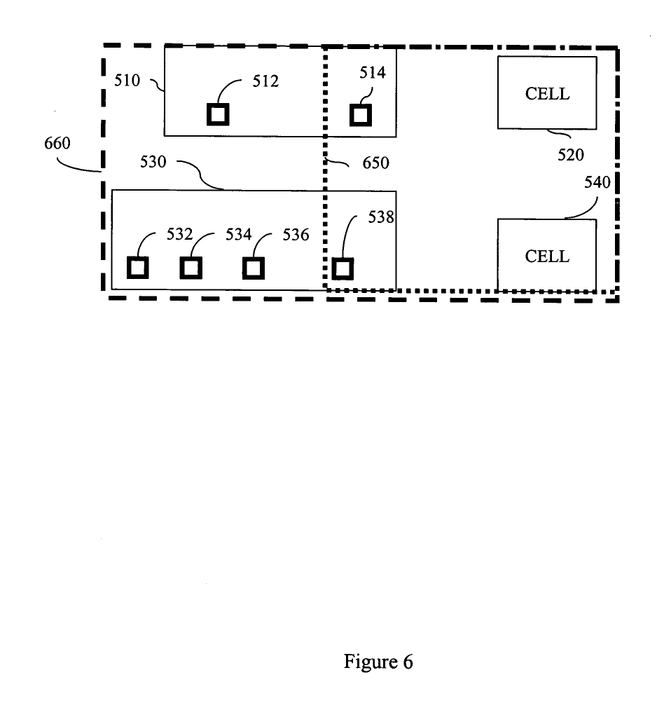

In FIG. 5, a design 500 includes cells 510, 520, 530, and 540. If cell 510 can be connected to another cell(s) in the design 500 by either of the pins 512 or 514 and if cell 530 can be connected to another cell(s) in the design 500 by any of the pins 532, 534, 536, and 538, then several bounding boxes could be computed for the placement 500. By way of illustration, FIG. 6 shows a first bounding box 650 for the design 500 and a second bounding box 660 for the design 500. While both bounding boxes 650 and 660 cover the cells 510, 520, 530, and 540 it is clear that bounding boxes 650 and 660 have different dimensions, which could lead to different estimates for the minimizing criteria. Bounding box 660 may be an example of an initial bounding box while bounding box 650 may be an example of a reduced bounding box. While FIGS. 5 and 6 illustrate designs with a single net, it is to be appreciated that a design may have multiple nets for which multiple bounding boxes may be computed.

Given a VLSI cell design produced, for example, by a placement process (e.g., genetic algorithm), the systems, methods, and so on described herein facilitate computing a reduced, near minimal, and/or minimal bounding box for nets in the design. This in turn facilitates determining whether the design meets pre-determined, configurable parameters like total wire length, maximum wire length, total congestion, total delay, maximum delay, and so on.

One example logic can be configured to compute a reduced bounding box where a cell in a design may include two or more pins by which it may be connected to another cell in the design. The logic may be configured to create an electronic record of pins and ports on cells connected to the net for which a bounding box is to be reduced. The record may be, for example, an entry in a table, a set of related entries in a set of data structures (e.g., arrays, lists), and the like. The record may store information like the (x,y) position of a pin in a cell, the port in which the pin is located, whether the pin is a candidate to be included in the bounding box, whether the pin has been logically excluded from the bounding box, whether a pin is currently on the edge of an intermediate bounding box and so on. The logic may be configured to produce an initial bounding box(es), and a reduced bounding box. “Intermediate bounding box” refers to a bounding box that is produced from the initial bounding box or a previous intermediate bounding box and thus can refer to an interim bounding box that may be produced during the processing of the logic as it progresses from an initial bounding box to a reduced bounding box.

The example logic may also be configured to store pointers to the pins and/or pin identifiers in a data structure. The data structure may be, for example, an array, a list, and the like. In one example, two arrays are created, a byX array and a byY array. The byX array may store the x position of pins while the byY array may store the y position of pins. The byX array and byY array may be referred to by those names in pseudocode and other descriptions of processing performed by an example logic below.

The example logic may also be configured to arrange the pointer data and/or the records of pins and ports stored in the data structures in a manner that facilitates taking actions associated with producing a reduced bounding box. The actions can include, but are not limited to, identifying “corner cases of pins”, identifying pins that are candidates for removal from the intermediate bounding box, and identifying edges in the intermediate bounding box that are candidates for being moved. In one example, the byX array is sorted by the x locations of pins and the byY array is sorted by the y location of pins.

The example logic may also be configured to identify “corner cases of pins”. A corner case exists when the pins in a corner of the intermediate bounding box are part of the same port, and thus may be dealt with more collectively, which facilitates increasing the efficiency of the bounding box computations since two edges may be moved as the result of an operation. Identifying a corner case can include determining that pins on two adjacent edges (e.g., top and left, bottom and right) belong to the same port, determining that a port has more than one pin, and determining that the port does not have pins on opposite edges (e.g., top and bottom, left and right).

The example logic may also be configured to remove pins in corner cases. In one example, removing pins in corner cases can include initially processing the byX array and then subsequently processing the byY array. Initially processing the byX array may include locating the beginning pin (e.g., on left edge) or ending pin (e.g., on right edge) in the array and computing the Manhattan distance to the corner for the pins in the port that was identified as having corner case pins. The Manhattan distance is the sum of the vertical distance to the horizontal edge that is one intersecting line in the corner and the horizontal distance to the vertical edge that is the other intersecting line in the corner. The initial processing of the byX array may also include sorting the pins in the port by Manhattan distance to facilitate identifying which pin to select for reducing the size of the bounding box. The initial processing of the byX array may also include placing the pins, as sorted by Manhattan distance, into a data structure like an array, where the pins are arranged from greatest Manhattan distance to least Manhattan distance. The pin with the greatest Manhattan distance is likely to have the greatest effect on reducing the size of the bounding box and thus is a candidate for becoming a corner of the intermediate bounding box. The pins with lesser Manhattan distances are candidates for being logically collectively removed from the bounding box.

The subsequent processing of the byY array may include locating the beginning pin (for the bottom edge) or end pin (for the top edge) in the array. The subsequent processing may also include locating the first pin in the next port and identifying the pins in the port from which the beginning or end pin was selected. From the pins in the port from which the beginning or end pins were selected, the example logic may locate a pin with the greatest Manhattan distance to the corner where the pin is below (for the bottom edge) or above (for the top edge) the first pin in the next port. This processing facilitates selecting the pin to become the new corner of the bounding box being below (for the bottom edge) or above (for the top edge) the pin from a different port. The example logic may then logically exclude other pins and decrement the number of pins left for ports of the excluded pins.

The example logic may also be configured to selectively remove pins and move edges to reduce the size of the bounding box after the corner cases have been handled. This may be referred to as handling non-corner cases and/or handling post-corner cases. Handling these non-corner cases may include, for example, creating a four element data structure (e.g., an edge array) that includes an element per side (edge) of the intermediate bounding box. Thus, there may be an entry for the top, bottom, left, and right sides (edges) in the intermediate bounding box. While four sides (e.g., top, bottom, left, right) are identified, it is to be appreciated that similar processing for bounding boxes with other orientations (e.g., diamond shapes) and other numbers of sides is contemplated.

The elements in the edge array may store data like information concerning the identity of the current edges of the intermediate bounding box, pins that are associated with the edges of the intermediate bounding box, the next pin closer to the center of the intermediate bounding box, and the vertical distance (for the top and bottom edges) or the horizontal distance (for the left and right edges) between the pin associated with the edge and the next pin closer to the center. The edge array may then be sorted in descending order (e.g., greatest distance first) by the distance between the pin associated with the edge and the next pin closer to the center.

The edge array may then be populated from the first and last pins of the byX and byY arrays that are still included after the corner cases have been handled. Thus, the first pin in the byX array will have the minimum x position and will be the initial left edge of the intermediate bounding box after the corner cases have been handled. The last pin in the byX array will have the maximum x position and will be the initial right edge of the intermediate bounding box after the corner cases have been handled. The first pin in the byY array will have the minimum y position and will be the initial bottom edge of the intermediate bounding box after the corner cases have been handled. The last pin in the byY array will have the maximum y position and will be the initial top edge of the intermediate bounding box after the corner cases have been handled. With this data so arranged, for the edges, the example logic can compute the distance to the next pin that is still included by examining the next pin in the byX or the byY array that is still included, and thus determine which edges to move, and to what location to move them. This may continue, for example, until a reduced, near minimal, and/or minimal bounding box is produced. Additionally, and/or alternatively, the example logic may continue processing until a bounding box that yields design values that meet one or more pre-determined, configurable thresholds is produced.

The following pseudocode illustrates one possible method by which the edges can be moved.

```
While (edge array not empty)
{
    this_pin = edge pin of first element in edge array
    if ( number of pins left for port of this_pin == 1 )
    {
        keep_pin = TRUE
    }
    else
    {
        keep_pin = FALSE
        exclude this_pin
        decrement number of pins left for port of this_pin
    } // end else
    for each (element in edge array)
    {
        if ((keep_pin == TRUE) && (this_pin is the edge pin))
        {
            remove this element from edge array
        }
        else if (((keep_pin == FALSE) &&
            ((this_pin is the edge pin) or (this_pin is the next pin
            of this element)))
        {
            starting with this element's edge pin
                find first and second pin in byY or byX that are still
                included
                establish these as new edge pin and next pin of this
                element
                compute new distance
                insert new distance in sorted location in edge array
        }
    } // end for each
} // end while
```

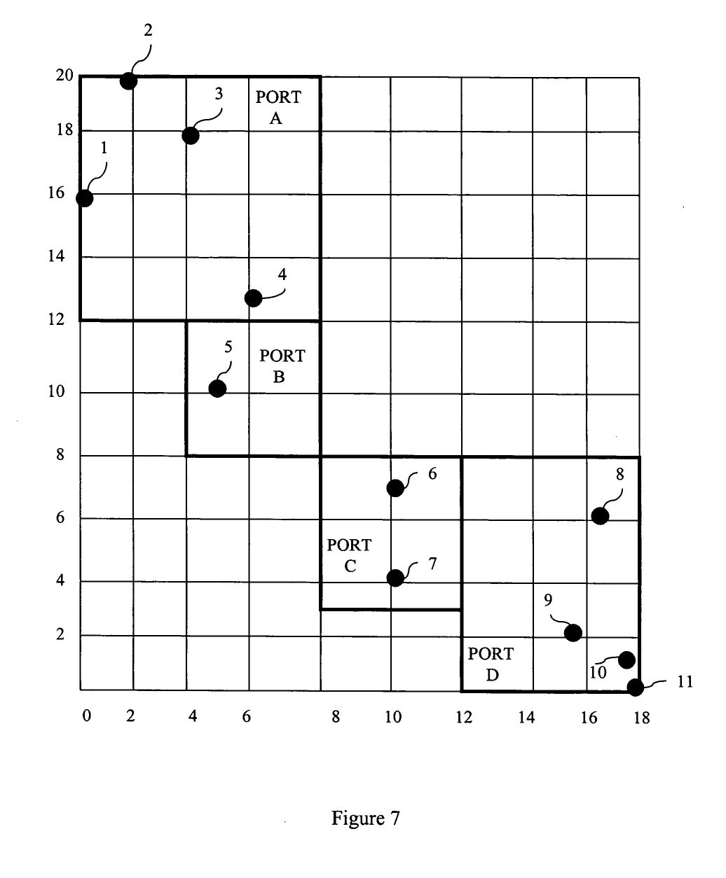

To illustrate processing that can be performed by an example logic, two examples will now be examined. The example processing may include references to the above listed pseudocode and example data structures described herein (e.g., byX, byY). In the examples, the boxes labeled Port A through Port D represent cells in the design illustrated in FIGS. 7-10. Pins shown in a cell are assumed to belong to the same port of the cell. So, in FIG. 7, pins 1, 2, 3, and 4 belong to port A, pin 5 belongs to Port B, pins 6 and 7 belong to Port C, and pins 8-11 belong to Port D.

After creating a set of electronic records configured to store information about pins and ports connected to a net in a design for which a bounding box is to be reduced, storing pointers to pins in a data structure and selectively arranging the data to facilitate identifying corner cases, removal candidate pins, and movement candidate edges, the following example data structures may be populated with the following example values:

| List of Ports | | List of Pins | | | byX array | byY array |
|---|---|---|---|---|---|---|
| Port | # of pins | Pin | Port (x, y) | included | Pin | Pin |
| A | 4 | 1 | A (0, 16) | yes | 1 <left | 11 <bottom |
| B | 1 | 2 | A (2, 20) | yes | 2 | 10 |
| C | 2 | 3 | A (4, 18) | yes | 3 | 9 |
| D | 4 | 4 | A (6, 13) | yes | 5 | 7 |
| | | 5 | B (5, 10) | yes | 4 | 8 |
| | | 6 | C (10, 7) | yes | 7 | 6 |
| | | 7 | C (10, 4) | yes | 6 | 5 |
| | | 8 | D (16, 6) | yes | 9 | 4 |
| | | 9 | D (15, 2) | yes | 8 | 1 |
| | | 10 | D (17, 1) | yes | 10 | 3 |
| | | 11 | D (18, 0) | yes | 11 <right | 2 <top |

In the example, a List of Ports array stores a set of records that include information about a port name and the number of pins a port still has available for determining a reduced bounding box. A List of Pins array stores information about pins, their (x,y) position, and whether they are still included for consideration in the intermediate bounding box. A byX array stores pin data that has been sorted so that the leftmost pin appears at the top and the rightmost pin appears at the bottom. Similarly, a byY array stores pin data that has been sorted so that the bottommost pin appears at the top and the topmost pin appears at the bottom.

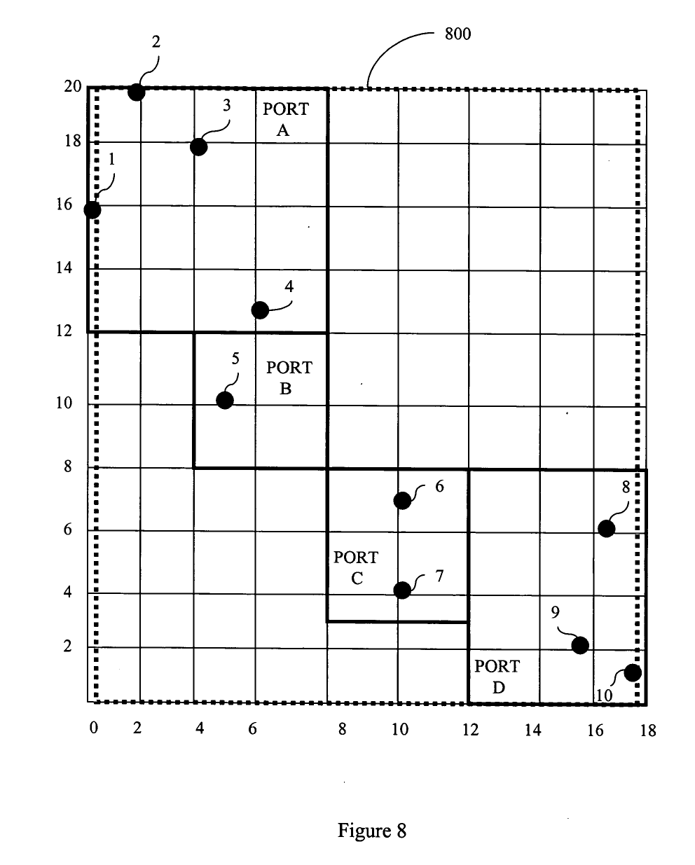

At this point, the initial bounding box is defined by the corners (0,0), (18,0), (0,20), and (18,20) as illustrated in FIG. 8. This is a pessimistic bounding box, but one that might be produced by systems that do not consider that the ports covered by the bounding box may have more than one pin by which they can be connected to another cell(s) and thus that the bounding box may be reduced by considering the multiple connection points. With continued reference to FIG. 7, in the sorted byX array, the leftmost pin, pin 1, is pointed to by a pointer. Similarly, the rightmost pin, pin 11, is pointed to by a pointer. Likewise, in the byY array, the top pin, pin 2, and the bottom pin, pin 11, have pointers pointing to them. While identifying and handling corner cases, note that the top pin (pin 2) and left pin (pin 1) are part of the same port (Port A). Also, Port A has more than one pin, the left and right pins do not belong to the same port, and the bottom and top pins do not belong to the same port. Thus the special case for processing corner cases of pins for the top-left corner can be performed. Starting with the left pin in the byX array, compute the Manhattan distance for pins 1, 2, and 3. Stop with pin 3 because pin 5 belongs to a different port. The sorted distance array will be:

| Pin | Distance |
|---|---|
| 3 | 6 |
| 1 | 4 |
| 2 | 2 |

Now, using the byY array, the example logic finds the first pin from the top that does not belong to port A, which is pin 5. Thus, establishing pin 3 as the new corner will most reduce the bounding box and yet still leave the bounding box covering a set of pins that connect the cells will be above 5. Pin 3 has the largest Manhattan distance and is above pin 5, so pin 3 is selected. Pins 1 and 2 are excluded, the number of pins on A is decremented to 2, the left pin is moved to pin 3, and the top pin is moved to pin 3. In this way, two edges were moved simultaneously on the intermediate bounding box, which facilitates increasing the efficiency of reducing the bounding box.

The bottom pin (pin 11) and right pin (pin 11) are also part of the same port (Port D). Also, Port D has more than one pin, the left and right pins do not belong to the same port, and the bottom and top pins do not belong to the same port. Thus the special corner case of pins processing for the bottom-right corner can be performed. Starting with the right pin in the byX array, compute the Manhattan distance for pins 11, 10, 8, and 9. Stop with pin 9 because pin 6 belongs to a different port. The sorted distance array will be:

| Pin | Distance |
|---|---|
| 8 | 8 |
| 9 | 5 |
| 10 | 2 |
| 11 | 0 |

Now, using the byY array, the logic finds the first pin from the bottom that does not belong to port D, which is pin 7. The pin that will facilitate efficiently reducing the size of the intermediate bounding box will be below pin 7. Pin 8 has the largest Manhattan distance, but it is not below pin 7, so skip pin 8 in the distance array. Pin 9 is below pin 7, so pin 9 is chosen. Pins 10 and 11 are excluded, the number of pins on Port D is decremented to 2, the right pin is moved to pin 8, and the top pin is moved to pin 9. Once again, two edges on the intermediate bounding box are moved simultaneously, which facilitates increasing computational efficiency.

After identifying and handling the corner cases, the following example data structures may be populated with the following example values:

| List of Ports | | List of Pins | | | byX array | byY array |
|---|---|---|---|---|---|---|
| Port | # of pins | Pin | Port (x, y) | included | Pin | Pin |
| A | 2 | 1 | A (0, 16) | no | 1 | 11 |
| B | 1 | 2 | A (2, 20) | no | 2 | 10 |
| C | 2 | 3 | A (4, 18) | yes | 3 <left | 9 <bottom |
| D | 2 | 4 | A (6, 13) | yes | 5 | 7 |
| | | 5 | B (5, 10) | yes | 4 | 8 |
| | | 6 | C (10, 7) | yes | 7 | 6 |
| | | 7 | C (10, 4) | yes | 6 | 5 |
| | | 8 | D (16, 6) | yes | 9 | 4 |
| | | 9 | D (15, 2) | yes | 8 <right | 1 |
| | | 10 | D (17, 1) | no | 10 | 3 <top |
| | | 11 | D (18, 0) | no | 11 | 2 |

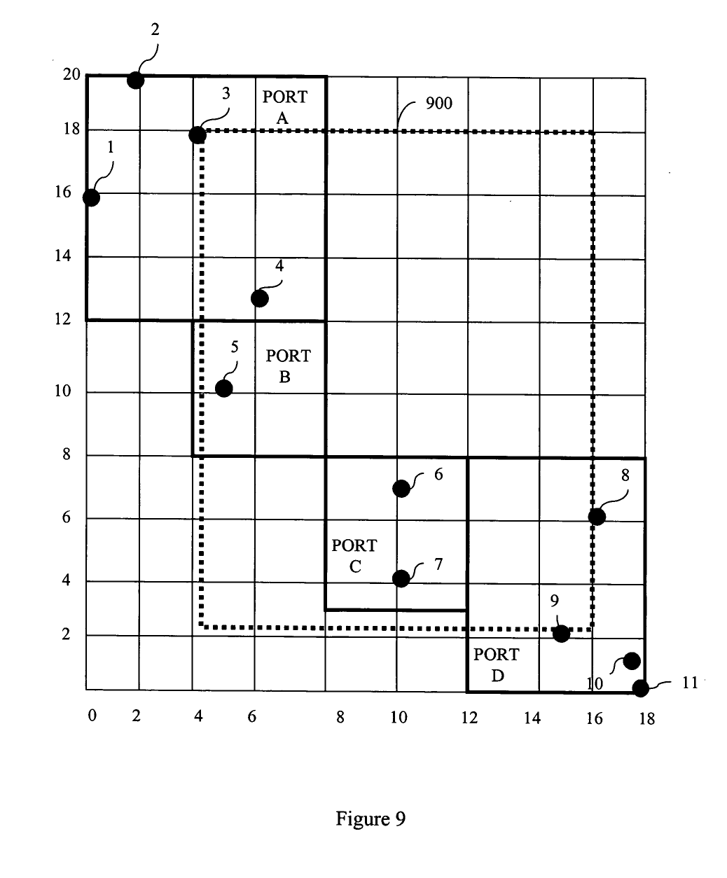

At this point the intermediate bounding box is defined by the corners (4,2), (16,2), (4,18), and (16,18) as illustrated in FIG. 9. The corner (4,2) is defined by the intersection of the left edge as determined by pin 3 and the bottom edge as determined by pin 9.

Now the example logic prepares to selectively remove pins and move edges to reduce the size of the bounding box (e.g., handle non-corner cases) by creating and processing an edge array. The sorted edge array will be:

| Edge | Edge Pin | Next Pin | Distance |
|---|---|---|---|
| top | 3 | 4 | 5 |
| bottom | 9 | 7 | 2 |
| left | 3 | 5 | 1 |
| right | 8 | 9 | 1 |

Note that the next pin for the top edge is not pin 1, even though it is the next pin in the byY array, since it has been excluded. For the first iteration of handling non-corner cases, the example logic gets the first entry of the edge array, which is the top edge. “this_Pin” will be pin 3. Since the port of pin 3, port A, has more than one pin left, “keep_pin” will be false, pin 3 is excluded, and the number of pins in port A is decremented to 1. The example logic then goes through the elements in the edge array, and finds the top and left edges need to be recomputed since both of these had pin 3. The new edge array is:

| Edge | Edge Pin | Next Pin | Distance |
|---|---|---|---|
| top | 4 | 5 | 3 |
| bottom | 9 | 7 | 2 |
| left | 5 | 4 | 1 |
| right | 8 | 9 | 1 |

Now, the example logic does another iteration of handling non-corner cases. This time, “this_pin” is pin 4, and its port (Port A) has only one pin left, so “keep_pin” is true. The example logic goes through the elements of the edge array and finds it needs to remove the top edge from the edge array.

For the third iteration of handling non-corner cases, “this_pin” is pin 9 from the bottom edge. Port D still has two pins, so “keep_pin” is false, pin 9 is excluded, and the number of pins on Port D is decremented to 1. Both the bottom and right edges are recomputed, and the new edge array is:

| Edge | Edge Pin | Next Pin | Distance |
|---|---|---|---|
| right | 8 | 6 | 6 |
| bottom | 7 | 8 | 2 |
| left | 5 | 4 | 1 |

For the fourth iteration of handling non-corner cases, “this_pin” is pin 8 from the right edge. Since this is the last pin of Port D, “keep_pin” is true and the right edge is deleted from the edge array indicating that it has reached a position that will produce a reduced, and/or minimal bounding box. For the fifth iteration, “this_pin” is pin 7 of the bottom edge. Port C (pin 7's port) has two pins left, so “keep_pin” is false, pin 7 is excluded, the number of pins on Port C is decremented to 1, and the bottom edge is recomputed. After this, the edge array is:

| Edge | Edge Pin | Next Pin | Distance |
|---|---|---|---|
| bottom | 8 | 6 | 1 |
| left | 5 | 4 | 1 |

For the final two iterations of handling non-corner cases, the logic finds that pin 8 of the bottom edge and pin 5 of the left edge are the last pins of their respective ports, so the pins are retained and the edges are deleted from the edge array indicating that those edges have arrived at the position that will produce a reduced and/or minimal bounding box. After this, the edge array is empty, and the processing of the logic ends. The final data looks like:

| List of Ports | | List of Pins | | | byX array | byY array |
|---|---|---|---|---|---|---|
| Port | # of pins | Pin | Port (x, y) | included | Pin | Pin |
| A | 1 | 1 | A (0, 16) | no | 1 | 11 |
| B | 1 | 2 | A (2, 20) | no | 2 | 10 |
| C | 1 | 3 | A (4, 18) | no | 3 | 9 |
| D | 1 | 4 | A (6, 13) | yes | 5 <left | 7 |
| | | 5 | B (5, 10) | yes | 4 | 8 <bottom |
| | | 6 | C (10, 7) | yes | 7 | 6 |
| | | 7 | C (10, 4) | no | 6 | 5 |
| | | 8 | D (16, 6) | yes | 9 | 4 <top |
| | | 9 | D (15, 2) | no | 8 <right | 1 |
| | | 10 | D (17, 1) | no | 10 | 3 |
| | | 11 | D (18, 0) | no | 11 | 2 |

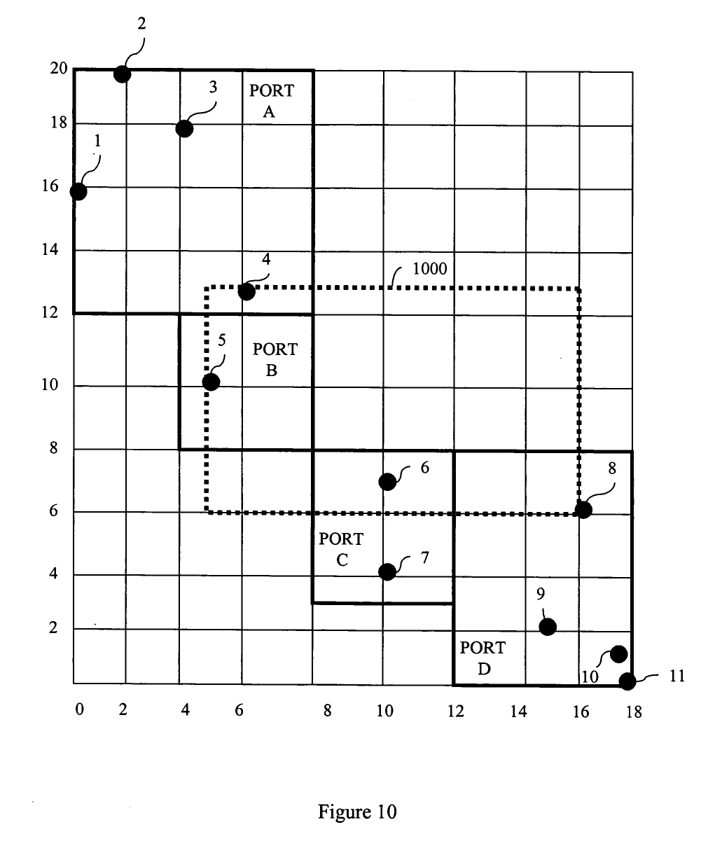

and the reduced bounding box 1000 is defined by the corners (5,6), (16,6), (16,13), and (5,13) as illustrated in FIG. 10.

Bounding box 1000 is smaller than the intermediate bounding box 900 (FIG. 9) and the initial bounding box 800 (FIG. 8), illustrating a reduced bounding box. It is to be appreciated that in some cases the example systems and methods may terminate a process before the bounding box produced is the mathematically and/or geographically smallest bounding box possible (e.g., the minimal bounding box). Thus, in some cases, the example systems and methods may compare a reduced bounding box to a pre-determined, configurable threshold(s) to determine acceptability. Similarly, the example systems and methods may compare the rate at which a bounding box is being reduced to determine whether to continue reducing the bounding box for a design or whether to move on to another design.

The reduced bounding box 1000 could be employed in computing wiring estimates, timing delay estimates, congestion estimates, and so on. These estimates could then be employed, for example, to compare the design placement of Ports A-D as illustrated in FIGS. 8-10 with other candidate design placements. Based on the comparison, reduced bounding box 1000 may be displayed to a user, stored in a memory, and the like. Furthermore, based on the comparison, and/or on other factors like whether the reduced bounding box 1000 meets pre-determined, configurable threshold values, a signal may be generated by the example logic (or apparatus performing the example algorithm) to other processes and/or logic apparatus concerning the existence of the reduced bounding box 1000 and/or its quality.

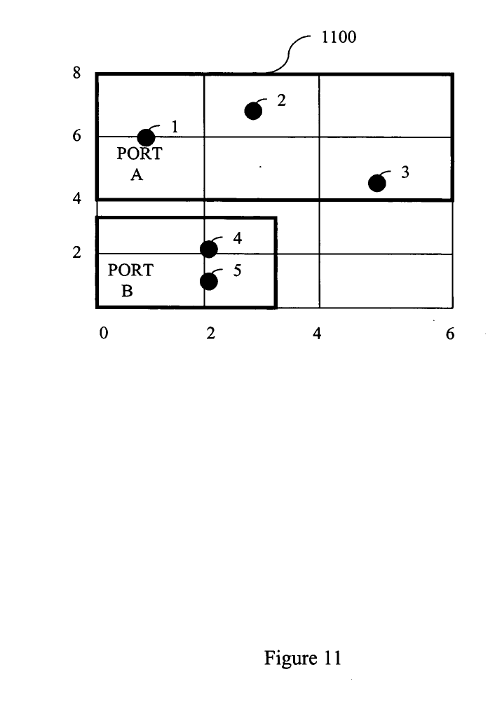

The following example concerns processing a more simple design than the previous example. This example illustrates a case that an example logic can be configured to handle but that was not examined in the previous example. The initial placement of two cells in a design is illustrated in FIG. 11. After creating records of pins and ports in the design 1100, storing pin data in a data structure and arranging the pin data in a manner that facilitates identifying corner cases, pins that are candidates for removal, edges that are candidates for being moved, and so on, the following example data structures may be populated with the following example data:

| List of Ports | | List of Pins | | | byX array | byY array |
|---|---|---|---|---|---|---|
| Port | # of pins | Pin | Port (x, y) | included | Pin | Pin |
| A | 3 | 1 | A (1, 6) | yes | 1 <left | 5 <bottom |
| B | 2 | 2 | A (3, 7) | yes | 4 | 4 |
| | | 3 | A (5, 5) | yes | 5 | 3 |
| | | 4 | B (2, 2) | yes | 2 | 1 |
| | | 5 | B (2, 1) | yes | 3 <right | 2 <top |

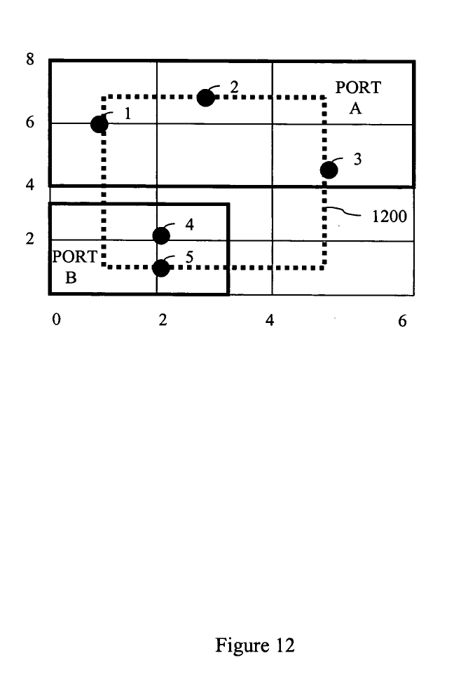

At this point, the initial bounding box 1200 is defined by the corners (1,1), (1,7), (5,1), and (5,7) as illustrated in FIG. 12. For example, the corner (1,0) is defined as the intersection of the left edge as determined by pin 1 and the bottom edge as determined by pin 5.

Removing pins in corner cases of pins is skipped for the top-left and top-right corners because the left and right pin both belong to port A. Removing pins in corner cases of pins is skipped for the bottom-left and bottom-right corners because the edge pins for these edges belong to different ports.

Thus, in this second example, it is shown that identifying and selectively removing pins in corner cases can include identifying that there are no corner case pins to handle. The example logic therefore moves on to handling non-corner cases, which may include creating the following edge array:

| Edge | Edge Pin | Next Pin | Distance |
|---|---|---|---|
| right | 3 | 2 | 2 |
| top | 2 | 1 | 1 |
| bottom | 5 | 4 | 1 |
| left | 1 | 4 | 1 |

In the first iteration of handling non-corner cases, pin 3 is “this_pin”. Since Port A has 3 pins, “keep_pin” is false, pin 3 is excluded, the number of pins on Port A is decremented to 2, and the right edge is recomputed. The edge array becomes:

| Edge | Edge Pin | Next Pin | Distance |
|---|---|---|---|
| right | 2 | 5 | 1 |
| top | 2 | 1 | 1 |
| bottom | 5 | 4 | 1 |
| left | 1 | 4 | 1 |

In the second iteration of handling non-corner cases, pin 2 is “this_in”. Since Port A has 2 pins, “keep_pin” is false, pin 2 is excluded, the number of pins on Port A is decremented to 1, and the right and top edges are recomputed. The edge array becomes:

| Edge | Edge Pin | Next Pin | Distance |
|---|---|---|---|
| top | 1 | 4 | 4 |
| bottom | 5 | 4 | 1 |
| left | 1 | 4 | 1 |
| right | 5 | 4 | 0 |

In the third iteration of handling non-corner cases, pin 1 is “this_pin”. Since Port A has only one pin left, “keep_pin” is true, and the top and left edges are deleted indicating that they have reached the position they will have in the reduced bounding box computed by the example logic. On the fourth iteration of handling non-corner cases, “this_pin” is pin 5. Since Port B has two pins, “keep_pin” is false, pin 5 is excluded, the number of pins on Port A is decremented to 1, and the bottom and right edges are recomputed. The edge array becomes:

| Edge | Edge Pin | Next Pin | Distance |
|---|---|---|---|
| bottom | 4 | 1 | 4 |
| right | 4 | 1 | 1 |

For the final two iterations of handling non-corner cases, the example logic finds that pin 4 is the last pin of Port A, so the pin is kept and the remaining two edges are deleted from the edge array indicating that they have also reached their position in the reduced bounding box. After this, the edge array is empty, and the logic concludes processing. The final data looks like:

| List of Ports | | List of Pins | | | byX array | byY array |
|---|---|---|---|---|---|---|
| Port | # of pins | Pin | Port (x, y) | included | Pin | Pin |
| A | 1 | 1 | A (1, 6) | yes | 1 <left | 5 |
| B | 1 | 2 | A (3, 7) | no | 4 <right | 4 <bottom |
| | | 3 | A (5, 5) | no | 5 | 3 |
| | | 4 | B (2, 2) | yes | 2 | 1 <top |
| | | 5 | B (2, 1) | no | 3 | 2 |

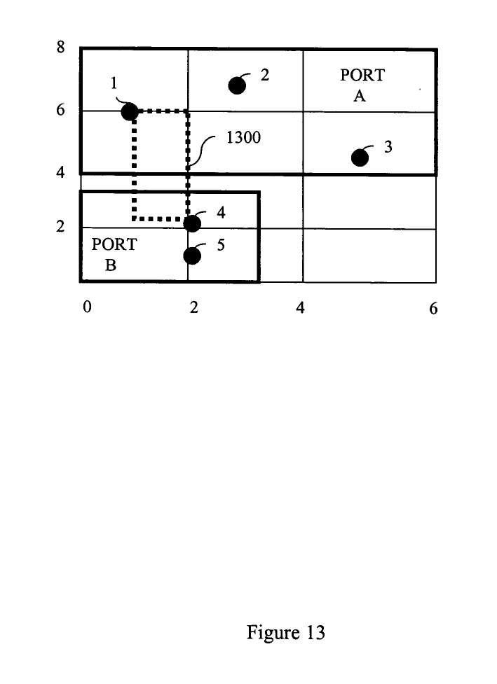

The corners of the reduced bounding box are now defined by (1,2), (1,6), (2,2), and (2,6) as illustrated in FIG. 13. For example, corner (1,2) is determined by pin 1 being on the left edge and pin 4 being on the bottom edge.

While the two examples provided above illustrate creating and reducing a bounding box with four sides through the electronic application of the computer executable methods, and while the two examples employ various data and data structures that can be stored in a computer memory, it is to be appreciated that variations to the algorithms, data, data structures and so on are anticipated.

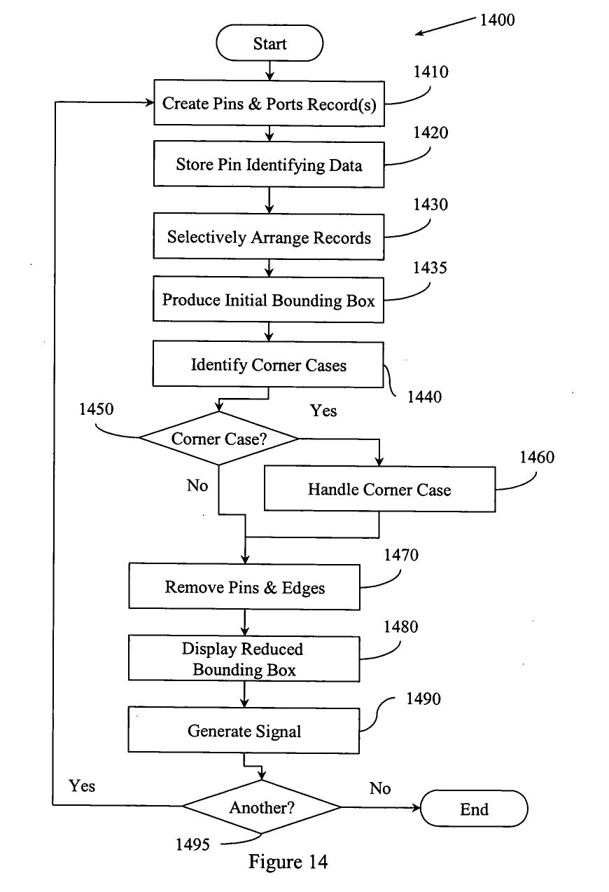

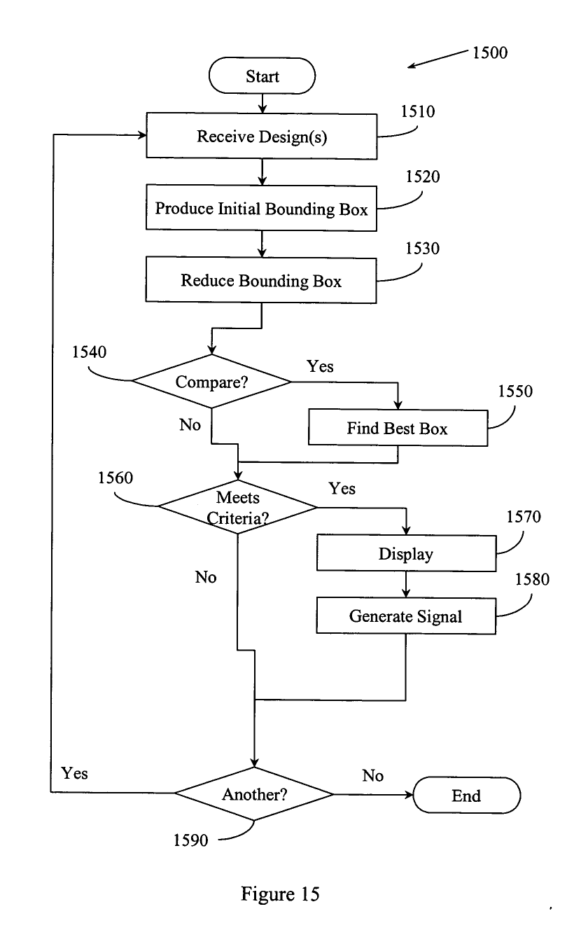

The Example method described above may be better appreciated with reference to the flow diagrams of FIGS. 14 and 15. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components.

FIG. 14 illustrates an example method 1400 for computing a reduced bounding box for a net in a VLSI design of cells, where a cell may include two or more pins by which the cell can be connected to at least one other cell in the design. A logic may be configured to perform method 1400. The method 1400 may include, at 1410, creating a set of electronic records configured to store data concerning pins and ports connected to a net in a design for which a reduced bounding box is to be produced. The records may include, for example, an (x,y) position of a pin of a cell in the design, a port in which the pin is located, an indicator concerning whether the pin is a candidate to be included in the reduced bounding box, an indicator concerning whether the pin has been logically excluded from the reduced bounding box, and whether a pin is currently on the edge of the intermediate bounding box. A record may be, for example, an entry in an electronic table(s), a set of related entries in a set of data structures (e.g., arrays) and so on. By way of illustration, a set of data structures may include a list of ports, a list of pins, an array for pins sorted by x position (a byX array), and an array for pins sorted by y position (a byY array).

The method 1400 may also include, at 1420, storing pin data in a data structure(s) configured to store pin data, where the pin data facilitates relating a pin to electronic records and/or data stored in those records. The pin data may be, for example, a pin identifier and/or a pointer to a pin.

The method 1400 may also include, at 1430, selectively arranging the records in a pre-determined order (e.g., in ascending order by x position, in descending order by Manhattan distance from a corner). Arranging the records in a pre-determined order may facilitate, for example, identifying when a port in a corner has pins that can be handled as special corner cases of pins, identifying that a pin is a removal candidate, identifying that an edge is a candidate to be moved, and so on.

The method 1400 may also include, at 1435, producing an initial bounding box. This initial bounding box may subsequently be reduced into an intermediate bounding box by handling a corner case of pins as described in association with steps 1440 through 1460. The intermediate bounding box can then be further reduced by removing pins and moving edges as described in association with step 1470.

Thus, the method 1400 may also include, at 1440, identifying corner cases of pins. Identifying a corner case can include, for example, identifying that two or more pins in a corner of the intermediate bounding box are in the same port, determining that a port has more than one pin, and determining that the port with multiple pins does not have pins on opposite edges of the intermediate bounding box. At 1450, a determination can be made concerning whether a corner case has been identified. If the determination at 1450 is Yes, then processing can continue at 1460.

At 1460, pins can be removed in a corner case. Removing pins in a corner case can include, for example, computing the Manhattan distance for pins in the array for pins arranged in order by x position, selecting the pin from the array with the greatest Manhattan distance to the corner with which the pins are associated, and selectively excluding pins that are not the pin with the greatest Manhattan distance. Removing pins in a corner case may also include, for example, computing the Manhattan distance for pins in the array for pins arranged in order by y position, selecting the pin with the greatest Manhattan distance, and selectively excluding pins that are not the pin with the greatest Manhattan distance. Thus, the initial bounding box can be reduced into an intermediate bounding box by handling the corner case of pins as described in association with step 1460.

The method 1400 may also include, at 1470, selectively removing pins and moving edges to further reduce the size of the intermediate bounding box. In one example, this may include creating a four element edge array, storing edge and pin data in the four element edge array, arranging the data in the four element edge array to facilitate identifying which edge will produce the largest reduction if moved, and selectively moving edges based on the data in the four element edge array.

In one embodiment, the method 1400 performs only the actions depicted from 1410 through 1470. In other embodiments, the method 1400 may perform additional actions like those described below.

The method 1400 may also include, at 1480, displaying the reduced bounding box. For example, the initial placement design may be displayed on a computer monitor and may be overlaid with the initial bounding box and the reduced bounding box. Additionally and/or alternatively, the initial design may be printed on a printer and the reduced bounding box may be drawn on the design. It is to be appreciated that the reduced bounding box may be displayed in other manners using other apparatus and/or processes. It is also to be appreciated that the reduced bounding box may be the mathematically and/or geographically minimal bounding box for the net in the design.

The method 1400 may also include, at 1490, generating a signal related to the reduced bounding box. For example, additional processes and/or apparatus may be waiting notification that an acceptable bounding box has been produced. Thus, if a bounding box that meets a certain pre-determined, configurable thresholds has been produced, then in one example a signal may be generated that causes data associated with the reduced bounding box to be communicated to additional processes and/or apparatus that may then proceed with additional VLSI CAD actions like producing a wiring diagram.

At 1495, a determination may be made concerning whether another bounding box is to be reduced. If the determination is Yes, then processing can return to 1410, otherwise processing can conclude.

While FIG. 14 illustrates various actions occurring in serial, it is to be appreciated that various actions illustrated in FIG. 14 could occur substantially in parallel. By way of illustration, a first process could create electronic records and store and sort the pin data, a second process could identify and handle corner cases and a third process could handle non-corner cases. While three processes are described, it is to be appreciated that a greater and/or lesser number of processes could be employed and that lightweight processes, regular processes, threads, and other approaches could be employed.

FIG. 15 illustrates a method 1500 for creating a reduced bounding box for a net in a VLSI design of cells that includes a cell(s) that includes two or more pins by which it may be connected to another cell(s) in the design. In one example, the reduced bounding box may be the mathematically minimal bounding box for the net in the design. The method 1500 may include, at 1510, receiving a design. The design can include two or more cells. A cell(s) may include more than one pin by which the cell can be connected to another cell(s). The design may be received from, for example, a VLSI CAD tool, a human user, a file, and so on. While FIG. 15 illustrates a design with a single net and computing a single bounding box for that single net, it is to be appreciated that a design may include, for example, several thousand nets. Thus, it is to be appreciated that the methods for computing a bounding box may be applied to the multiple nets in a design to produce a set of reduced and/or minimal bounding boxes.

At 1520, the method 1500 may include producing an initial bounding box for the net in the design. The initial bounding box may be a pessimistic estimate that covers substantially all the pins in substantially all the cells present in the design. In one example, if the pessimistic bounding box satisfies a pre-determined, configurable threshold(s) (e.g., total delay estimate), then the method 1500 may conclude. However, in the example, the initial bounding box may not meet the pre-determined, configurable threshold(s), the method 1500 may continue and reduce the bounding box. In another example, the method 1500 performs no initial check and proceeds to reducing the initial bounding box.

At 1530, the method 1500 may include reducing the bounding box. Reducing the bounding box can include, for example, establishing initial corner pins and selectively moving edges of the bounding box. In one embodiment, the method 1500 performs only the actions depicted from 1510 through 1530. In other embodiments, the method 1500 may perform additional actions like those described below.

In one example, the method 1500 may include, at 1540, determining whether a reduced bounding box is to be compared to other reduced bounding boxes produced for other designs for the nets. If the determination at 1540 is Yes, then at 1550 the reduced bounding box may be compared to other bounding boxes for the net and a bounding box can be selected based on one or more criteria like wiring route estimates, congestion estimates, delay estimates, and so on.

At 1560, a determination may be made concerning whether the reduced bounding box or the selected bounding box satisfies one or more pre-determined, configurable thresholds. If the determination at 1560 is Yes, then at 1570 the bounding box and/or data associated with the bounding box may be displayed. Additionally, and/or alternatively, at 1580 a signal concerning the bounding box may be generated. Thus, other processes and/or apparatus can acquire the data concerning the bounding box.

While FIG. 15 illustrates various actions occurring in serial, it is to be appreciated that various actions illustrated in FIG. 15 could occur substantially in parallel. By way of illustration, a first process could receive designs and produce initial bounding boxes, a second process could reduce the initial bounding box and a third process could determine whether a bounding box meets certain criteria (e.g., wiring length estimate) and thus selectively display the bounding box or generate a signal to another process and/or apparatus concerning the design. While three processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method for producing a reduced, near minimal, and/or minimal bounding box for a net in a VLSI design of cells, where at least one cell in the VLSI design of cells includes two or more pins by which the cell can be connected to at least one other cell. The method may include creating electronic records that can store information about pins and ports connected to a net in a design for which a bounding box is to be reduced. The method may also include storing pin data in data structures configured to store pin data. The pin data may facilitate relating a pin to an electronic record, selectively arranging the electronic records in a pre-determined order, and analyzing the selectively arranged electronic records to identify a corner case of pins. If a corner case of pins exists, the method may selectively remove pins in the corner case. After removing pins in corner cases of pins, which can include moving two edges at the same time and collectively removing sets of pins, the method may include repetitively selectively logically removing pins from inclusion in the bounding box and repetitively selectively moving an edge of the bounding box to be reduced. While the above method is described being stored on a computer-readable medium, it is to be appreciated that other example methods described herein can be implemented as software and can be stored on and/or transmitted by a computer-readable medium.

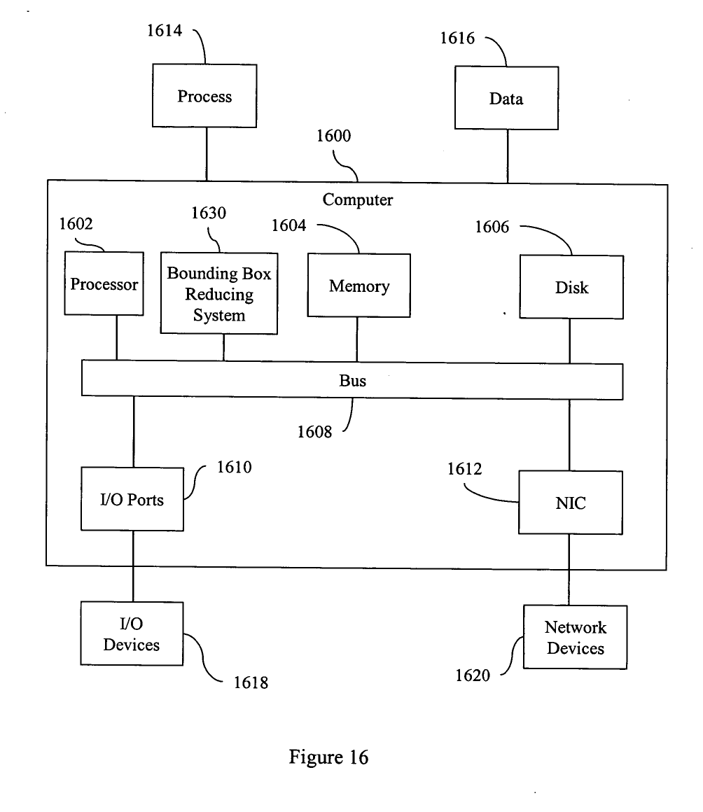

FIG. 16 illustrates a computer 1600 that includes a processor 1602, a memory 1604, a disk 1606, input/output ports 1610, and a network interface 1612 operably connected by a bus 1608. While these components are illustrated as being connected by the bus 1608, it is to be appreciated that the components may be operably connected by other connection routes and methods. The computer 1600 may also include a bounding box reduction system 1630. The bounding box reduction system 1630 may include, for example, a logic that performs the example methods described herein. The bounding box reduction system 1630 may also include, for example, a memory for storing data structures employed in reducing a bounding box. It is to be appreciated that other computers may also be employed with the systems and methods described herein. The bounding box reduction system 1630 may be permanently and/or removably associated with the computer 1600.

The processor 1602 can be a variety of various processors including dual microprocessor and other multi-processor architectures. The memory 1604 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 1606 can include, but is not limited to, devices like a magnetic disk drive, a solid state disk drive, a floppy disk drive, a tape drive, a Zip drive, a flash memory card, and/or a memory stick. Furthermore, the disk 1606 can include optical drives like, a compact disc ROM (CD-ROM), a CD recordable drive (CD-R drive), a CD rewriteable drive (CD-RW drive) and/or a digital versatile ROM drive (DVD ROM). The memory 1604 can store processes 1614 and/or data 1616, for example. The disk 1606 and/or memory 1604 can store an operating system that controls and allocates resources of the computer 1600.

The bus 1608 can be a single internal bus interconnect architecture and/or other bus architectures. The bus 1608 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 1600 interacts with input/output devices 1618 via input/output ports 1610. Input/output devices 1618 can include, but are not limited to, a keyboard, a microphone, a pointing and selection device, cameras, video cards, displays, and the like. The input/output ports 1610 can include but are not limited to, serial ports, parallel ports, and USB ports.

The computer 1600 can operate in a network environment and thus is connected to network devices 1620 by a network interface (NIC) 1612. Through the network devices 1620, the computer 1600 may interact with a network. Through the network, the computer 1600 may be logically connected to remote computers. The networks with which the computer 1600 may interact include, but are not limited to, a local area network (LAN), a wide area network (WAN), and other networks. The network interface 1612 can connect to LAN technologies including, but not limited to, fiber distributed data interface (FDDI), copper distributed data interface (CDDI), Ethernet/IEEE 802.3, token ring/IEEE 802.5, wireless/IEEE 802.11, Bluetooth, and the like. Similarly, the network interface 1612 can connect to WAN technologies including, but not limited to, point to point links, circuit switching networks like integrated services digital networks (ISDN), packet switching networks, and digital subscriber lines (DSL).

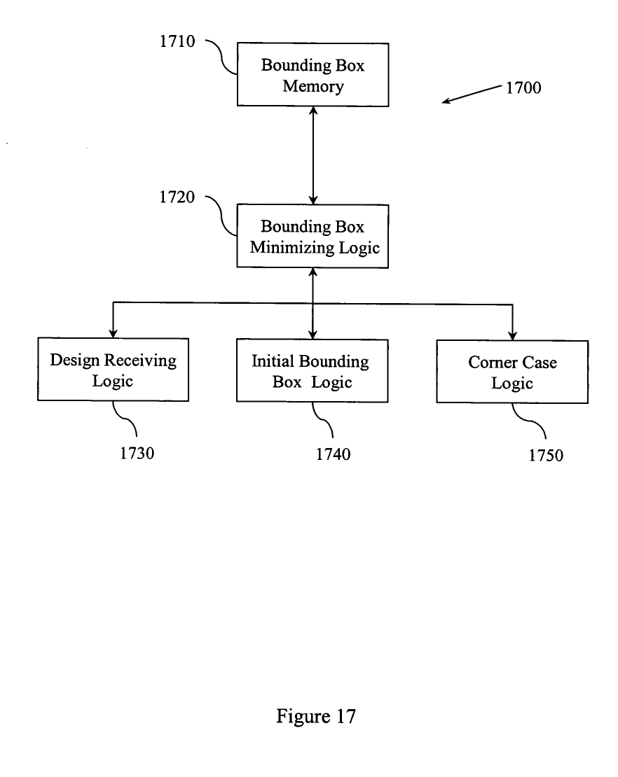

FIG. 17 illustrates a system 1700 that includes a bounding box memory 1710 configured to store design data associated with minimizing a bounding box for a net in a VLSI design of cells, where at least one cell in the design includes two or more pins by which it can be connected to at least one other cell in the design. The system 1700 also includes a minimizing logic 1720 operably connected to the bounding box memory 1710. The minimizing logic 1720 may be configured to compute a reduced, near minimal, and/or minimal bounding box for the net in the design. The minimizing logic 1720 may, therefore, be configured to receive the design of cells from locations including, but not limited to, a human user, a CAD tool, a file, an email, an Internet communication, and so on. The minimizing logic 1720 may also be configured to produce an initial bounding box for the net in the design. The minimizing logic 1720 may also be configured to minimize the bounding box for the net in the design. Minimizing the bounding box may include, for example, selectively re-establishing a corner pin in the intermediate bounding box under certain conditions. The conditions may include, for example, there being two or more pins in the same port in a corner of the intermediate bounding box, the port having more than one pin, and the port not having pins on opposite edges of the intermediate bounding box. Minimizing the bounding box may also include selectively moving edges of the bounding box.

In one example, the system 1700 may include a design receiving logic 1730 configured to receive the design and an initial bounding box logic 1740 configured to produce the initial bounding box. The system 1700 may also include a corner case logic 1750 configured to identify and/or remove pins from corner cases.

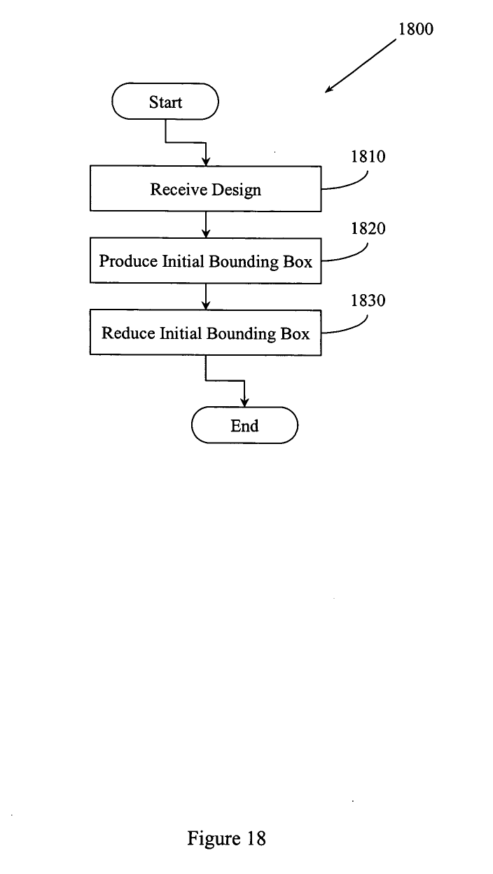

FIG. 18 illustrates an example method 1800 for computing a reduced bounding box for a net in a VLSI design of cells. The method 1800 may include, at 1810, receiving a VLSI design of cells. The VLSI design of cells may include at least one cell that has more than one pin by which it can be connected to another cell(s) in the design. The method 1800 may also include, at 1820, producing an initial bounding box for the net in the design. From the initial bounding box produced at 1820, the method may then, at 1830, reduce the initial bounding box. Thus, a reduced, near-minimal, and/or minimal bounding box may be produced for a net in a VLSI design of cells.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage, 624 (2d. Ed. 1995).

1. A method for producing a reduced bounding box for a net in a VLSI design of cells, where at least one cell in the design includes two or more pins by which the cell can be connected to at least one other cell in the design, the method comprising:
creating a set of electronic records configured to store information about one or more pins and one or more ports connected to the net in the design;
storing data about the one or more pins in one or more data structures configured to store pin data, where the data about the one or more pins facilitates relating the one or more pins to one or more electronic records in the set of electronic records;
selectively arranging the set of electronic records in a pre-determined order;
producing an initial bounding box for the net in the design;
analyzing the selectively arranged set of electronic records to identify a corner case of pins in the initial bounding box;
selectively removing pins in a corner case of pins to produce an intermediate bounding box from the initial bounding box;
reducing the size of the intermediate bounding box by repetitively selectively removing one or more pins from inclusion in the intermediate bounding box; and
producing the reduced bounding box by further reducing the size of the intermediate bounding box by repetitively selectively moving an edge of the intermediate bounding box.

2. The method of claim 1, where an electronic record in the set of electronic records includes one or more of, an (x,y) position of a pin in the design, the port in which the pin is located, an indicator concerning whether the pin is a candidate to be included in the reduced bounding box, an indicator concerning whether the pin has been logically excluded from the reduced bounding box, and an indicator concerning whether a pin is currently on an edge of an intermediate bounding box.

3. The method of claim 1, where an electronic record in the set of electronic records comprises an entry in a table.

4. The method of claim 1, where an electronic record in the set of electronic records comprises a set of related entries in a set of related data structures.

5. The method of claim 1, where an electronic record in the set of electronic records comprises a set of related entries in a set of related arrays.

6. The method of claim 1, where the pin data comprises one or more of, a pin identifier, and a pointer to a pin.

7. The method of claim 1, where the data structures configured to store pin data comprise one or more arrays.

8. The method of claim 7, comprising a first data structure configured to store pin data in order by x position.

9. The method of claim 8, comprising a second data structure configured to store pin data in order by y position.

10. The method of claim 9, where selectively arranging the set of electronic records includes:
sorting the pin data in the first data structure in order by x position; and
sorting the pin data in the second data structure in order by y position.

11. The method of claim 1, where the pre-determined order to which the set of electronic records is arranged facilitates one or more of, identifying a corner case, identifying a pin that is a candidate for removal from the intermediate bounding box, and identifying an edge in the intermediate bounding box that is a candidate to be moved.

12. The method of claim 1, where identifying a corner case of pins comprises:
identifying that two or more pins in a corner of the initial bounding box are in the same port;
determining that the port has more than one pin; and
determining that the port does not have pins on opposite edges of the initial bounding box.

13. The method of claim 10, where selectively removing pins in the corner case of pins comprises:
computing the Manhattan distance from one or more pins in the first data structure to the corner of the design in which the pins are located;
selecting the pin in the first data structure with the greatest Manhattan distance to the corner; and
selectively excluding pins from the first data structure that are not the pin in the first data structure with the greatest Manhattan distance.

14. The method of claim 13, where selectively removing pins in the corner case of pins comprises:
computing the Manhattan distance from one or more pins in the second data structure to the second corner of the design in which the pins are located;
selecting the pin in the second data structure with the greatest Manhattan distance to the second corner; and
selectively excluding pins from the second data structure that are not the pin in the second data structure with the greatest Manhattan distance.

15. The method of claim 1, where reducing the size of the intermediate bounding box by repetitively selectively removing one or more pins from inclusion in the intermediate bounding box and repetitively, selectively moving an edge of the intermediate bounding box comprises:
creating a four element edge array;
storing edge and pointer data in the four element edge array;
arranging the edge and pointer data in the edge array to facilitate determining which edge of the intermediate bounding box to move; and
selectively moving an edge of the intermediate bounding box based on the data in the four element edge array.

16. The method of claim 1, where the reduced bounding box comprises the minimal bounding box for the net in the design.

17. A computer-readable medium storing processor executable instructions operable to perform a method for producing a reduced bounding box for a net in a VLSI design of cells, where at least one cell in the design includes two or more pins by which the cell can be connected to at least one other cell in the design, the method comprising:
creating a set of electronic records configured to store information about one or more pins and one or more ports connected to the net in a design for which the reduced bounding box is to be produced;
storing data about the one or more pins in one or more data structures configured to store pin data, where the data about the one or more pins facilitates relating the one or more pins to one or more electronic records in the set of electronic records;
selectively arranging the set of electronic records in a pre-determined order;
producing an initial bounding box for the net in the design;
analyzing the selectively arranged set of electronic records to identify a corner case of pins in the initial bounding box;
selectively removing pins in a corner case of pins to produce an intermediate bounding box from the initial bounding box;
reducing the size of the intermediate bounding box by repetitively selectively removing one or more pins from inclusion in the intermediate bounding box; and
producing the reduced bounding box by further reducing the size of the intermediate bounding box by repetitively selectively moving an edge of the intermediate bounding box.

18. A method for computing a reduced bounding box for a net in a VLSI design of cells, comprising:
receiving a VLSI design of cells where at least one cell in the VLSI design of cells includes more than one pin by which it can be connected to at least one other cell in the design;
producing an initial bounding box for the net in the design; and
computing the reduced bounding box by reducing the initial bounding box.

19. The method of claim 18, where reducing the initial bounding box comprises:
selectively repetitively producing a intermediate bounding box that is smaller than the initial bounding box by:
selectively re-establishing one or more corner pins in the intermediate bounding box when there are two or more pins in a port in a corner of the intermediate bounding box, when the port has more than one pin, and when the port does not have pins on opposite edges of the intermediate bounding box; and
selectively moving one or more edges of the intermediate bounding box.

20. The method of claim 18, comprising:
displaying the reduced bounding box.

21. The method of claim 18, comprising:
selectively generating a signal associated with the reduced bounding box.

22. The method of claim 18, where the reduced bounding box is a minimal bounding box for the net in the design.

23. A computer-readable medium storing processor executable instructions operable to perform a method for computing a reduced bounding box for a net in a VLSI design of cells, comprising:
receiving a VLSI design of cells where at least one cell in the VLSI design of cells includes more than one pin by which it can be connected to at least one other cell in the design;
producing an initial bounding box for the net in the design; and
computing the reduced bounding box by reducing the initial bounding box.

24. A system, comprising:
a bounding box memory configured to store design data associated with a net in a design for which a bounding box is to be reduced, where at least one cell in the design includes two or more pins by which it can be connected to at least one other cell in the design; and
a reducing logic operably connected to the bounding box memory, where the reducing logic is configured to compute a reduced bounding box.

25. The system of claim 24, where the reducing logic is configured to:
receive the design;
produce an initial bounding box for a net in the design; and
reduce the bounding box for the net in the design by:
selectively re-establishing one or more corner pins in the bounding box when there are two or more pins in the same port in a corner of the bounding box, when the port has more than one pin, and when the port does not have pins on opposite edges of the bounding box; and
selectively moving one or more edges of the bounding box.

26. The system of claim 25, comprising:
a display configured to display the reduced bounding box.

27. The system of claim 24, where the reduced bounding box is the minimal bounding box for the net in the design.

28. The system of claim 24, comprising:
a design receiving logic configured to receive the design;
an initial bounding box logic configured to produce the initial bounding box for a net in the design; and
a corner case logic configured to identify or remove pins from a corner case of pins.

29. A system for producing a minimal bounding box for a net in a VLSI design of cells, where one or more cells may include two or more pins by which the one or more cells can be connected to one or more other cells, the system comprising:
means for receiving a VLSI design of cells;
means for producing an initial bounding box;
means for identifying pins in corners that may be excluded; and
means for moving edges in the bounding box.
